(19) United States
(12) Patent Application Publication
(10) Pub. No.: US 2001/0035873 A1
(43) Pub. Date: Nov. 1, 2001

(54) Method and system for deferred assignment of attributes in a computer graphics scene

(76) Inventor: David Easter, Raleigh, NC (US)

Correspondence Address: David L. McCombs, Haynes and Boone, LLP, Suite 3100, 901 Main Street, Dallas, TX, 75202-3789, US

(21) Appl. No.: 09/834,480

(22) Filed: Apr. 13, 2001

Related U.S. Application Data
(60) Provisional application No. 60/198,696, filed on Apr. 20, 2000.

(51) Int. Cl. G06F 17/00

(52) U.S. Cl. 345/632; 345/629; 345/681; 707/104.1; 707/101; 345/619

(57) ABSTRACT

An improved system and method is provided to defer the assignment of an attribute of an object in computer graphics. Through this improved method and system, a graphical object predefined in a computer graphics library can be reused with altered attributes. The operator first identifies the attribute expected to be altered and its corresponding attribute value. The attribute expected to be altered by the operator is included in an instance node related to the object along with the initial value.

### CROSS-REFERENCE

This application claims the benefits of the provisional application of U.S. patent application Ser. No. 60/200,100 which was filed on Apr. 27, 2000.

### BACKGROUND OF THE INVENTION

The present invention relates generally to data processing for computer graphics, and more particularly, to a system and method for processing three-dimensional computer-based graphics.

As it is known in the industry, a computer-based graphics processing system renders three-dimensional objects for display on a two-dimensional display device. From the perspective of the processing system, each object is defined and represented as a virtual graph of nodes. More specifically, the graph is most likely a directed and acyclic graph. Using this acyclic graph, a complex object can have an extensive virtual “tree” diagram with different nodes embedded therein. Each node usually represents a component of the object and holds a number of attributes of that component in an internal format. These graphs of different objects are built by a computer program sometimes known as the “graphics editor,” which allows an operator to select components from a library of previously defined components. At a minimum, the library contains lines, arcs and surfaces. As components are built from these basic elements, they themselves may be saved in the library for further use. Over time, the library may contain a large number of components and objects which may be used or combined with other components to create objects of arbitrary complexity. However, the complexity of the objects is not obvious to the operator because each object is encapsulated so that it may be operated on as a single entity. The encapsulation entails assigning the attributes of the component values which are stored in the object library. Thus when an object is retrieved from the library, the saved attributes are also retrieved.

In most cases, it is not required that all attributes of the object be assigned with values. Unassigned attributes are given values from the “environment” in which they are placed. When an object is placed in a scene, the graph representing the object is added to the graph representing the scene making a larger and more complex graph. As mentioned above, the graph is likely in a tree form, and an unassigned attribute can get its value by “walking” through the graph from the object node (where the attribute is) to the root of the tree and using a predetermined value found for its use. This process is referred to as a “default accumulation.” It can also be said that the object “inherits” the attribute from a “parent” or “ancestor” node of the graph. In most cases, it is desirable not to assign all attributes to an object when it is stored. For example, it is often desirable to allow the operator to assign color attributes to the object when it is placed in a scene. Thus these attributes would not be assigned in the stored object, but inherited when the object is placed in the scene.

Although the attributes which are unassigned when the object is stored in the library can be changed through inheritance, internal or fixed attributes of an object cannot be re-assigned. If any attributes need new values, a new object must be defined and must be saved in order to be re-used. This cumbersome process includes the steps of locating the node or the object which contains the value to be changed, changing the attribute value of the object, saving the changed object, and creating a copy with the new values in the library.

With the process of default accumulation, it is unlikely to override any fixed attribute within the object itself because the first value encountered in the path from a “leaf” node to the root for a fixed attribute is always the value provided by the object itself.

What is needed is a method for altering an attribute of an encapsulated object without having to save the altered object as a new object.

### SUMMARY OF THE INVENTION

An improved system and method is provided to defer the assignment of an attribute of an object in computer graphics. Through this improved method and system, a graphical object in a computer graphics library can be reused with altered attributes. A new occurrence of the object with different attributes is viewed by an operator as an independent entity while sharing other unaltered attributes with the object defined in the library.

In one example of the present invention, for reusing a graphical object in a computer graphics library with one or more assignable attributes, initial values for the assignable attributes are first provided when the object is defined. At least one assignable attribute of the graphical object expected to be altered can be identified when an instance of the graphical object is used, and the attribute value of the graphical object for the used instance can then be altered. The used instance is stored in the library as an entity containing only the assignable attributes while sharing other attributes as previously defined by the object.

Viewing from the perspective of the library, the object is stored as a node of a computer graphics scene. Further, the assignable attribute and its initial value are stored in a virtual instance node related to the node of the object. A predetermined attribute value for the identified assignable attribute can be found from one or more nodes connected directly or indirectly with the node of the object to alter the value of the identified assignable attribute.

### BRIEF DESCRIPTION OF THE DRAWINGS

FIG. 1 illustrates a simplified virtual tree form representing objects in a scene which is used for constructing computer graphics.

FIG. 2 illustrates a virtual tree form representing a scene with two objects.

FIG. 3 illustrates a virtual tree form representing a scene with two objects with corresponding instance nodes according to one embodiment of the present invention.

### DETAILED DESCRIPTION

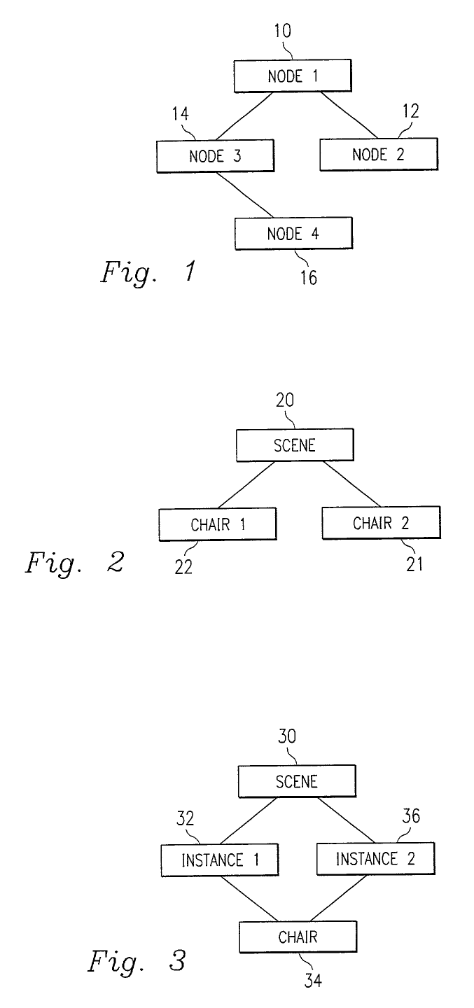

Referring to FIG. 1, an object 10 is shown in a virtual tree diagram form including one or more nodes. It is assumed that a computer program, e.g., a graphics editor, allows the placement of various objects within a graphics scene. These objects may be retrieved from a library of predetermined objects, each of which may be further represented by a virtual graph of nodes. For example, each node 12, 14, or 16 of the object 10 contains various attributes for that component or node of the object. If an attribute is not declared or assigned in the node itself, the value of that attribute can be found by taking the path from that node upward to the root of the tree form and using or “inheriting” the first value found for this attribute in the most direct parent. As it is known in the industry, various standard rules of inheritance can apply when two or more parents are equally direct. For example, if an attribute in Node 4 (numeral 16) does not have an assigned value, the graphic editor goes on a level higher to Node 3 (numeral 14) to seek any value used or provided for this particular attribute. If it is still not found, Node 1 (numeral 10) will be searched for the value. If a value either in Node 3 or Node 1 is in existence for this attribute, it will be used as Node 4 “inherits” the value from the environment it is in.

Referring to FIG. 2, the graphic editor usually starts the construction of a computer graphic “scene” with a single node 20 representing the scene. Attributes defined for this top level node provide overall attributes of the entire scene. The operator of the graphic editor usually have the ability to assign values to any non-fixed or assignable attributes of that node. Using the graphic editor, the operator looks at a predetermined library of stored objects and selects an object 22 such as a chair object to be included in the scene. In this example, it is assumed that the object is a simple chair of four straight, wooden legs, a white cloth seat, a wooden back, and no arms. The texture of the seat is a coarse straight weave, and the texture of the wooden parts is “maple.” Moreover, the chair object 22 is represented by a graph of nodes representing the geometry and attributes of the component parts (arms, legs, seat, etc.) of the chair.

While selecting the chair as an object, the operator is unaware of the internal structure of the chair. In the above graph, the scene node 20 does not alter any fixed attribute of the chair node 22 so that the chair appears just as it was defined and saved in the library. Similarly, using the graphics editor, the operator can add an additional chair 24. Suppose the operator wanted to have the chair represented by chair node 22 to have a white seat and the other chair (the chair node 24) to have a black seat. Assuming each chair object was defined with the seat color attribute predefined in the chair object as an assignable attribute, the operator can override any “default” color of the seat by assigning a new attribute value to the chair node 24.

Referring to FIG. 3, a simplified example is shown illustrating how the assignments of various attributes of objects in computer graphics can be deferred and altered. Since components of a computer graphics image is represented by virtual nodes, each node is labeled or named, and the node label is used by the graphics editor to locate the node when an assignable attribute of the node is changed. Assuming a scene node 30, which is the root node of the virtual tree form or acylic graph, represents a graphic scene yet to be constructed, it may have zero or more other nodes representing objects already placed within the scene. When an object is to be added to a scene node 30, two things are added to the entire graph. First, an “instance” node 32 is added as a child of the root node (the scene node 30). Next an object node 34 representing an object will be added as a child node of the instance node 32. The operator will likely include in the instance node 32 all the values of assignable attributes which are not specifically defined within the object node 34. Hence, the object node 34, under the instance node 32, can inherit these values because they bear a parent-child relationship.

For example, the value of color attribute would not be assigned in the object node but is left for the operator to determine when he places the object 34 within the scene. In this way, two instances of the same object may have different colors. If only a single instance of an object occurs in the scene, the instance node may not be used, in which case an object graph is added under the graph of the scene directly. That is, the object node is connected to the scene node directly without going through any instance node. If the same object is reused in the scene with some alterations to its assignable attributes, the graph representing a new occurrence of the object is constructed using the previously retrieved or pre-existing object graph, a second instance node, such as Instance 2 (numeral 36), is identified to represent the second or subsequent instance of the object.

In this new instance node 36, all attributes expected to be altered are included. Specifically, for each assignable attribute which the operator wishes to override, the attribute and its new value are first identified by the operator. Then, the assignable attributes and their values are then added as “deferred” attributes to a parent/ancestor node of the instance node 36 such as node 30. Therefore, defining a value for an attribute in the instance node, rather in the object node, functions as an improved method to assign the value to an assignable attribute of the object node.

In the above described structure for re-using predefined objects, the value for each attribute of the added object is determined by the following process whenever a new occurrence of an object takes place. First, the values of the assignable attributes are “accumulated” using the default accumulation method, i.e., seeking the value from the first node containing a predetermined value for the attribute. Next, the ancestor nodes of the object, such as the instance nodes, are interrogated if they contain any “deferred” attribute and its corresponding value, the attribute of the object is then changed to the deferred attribute value given in the instance node. If there are still “deferred” attributes of the object left with no assigned values identified, the parent nodes of the instance node are then further interrogated until either all deferred attributes are assigned with values, or until the root of the virtual tree form is reached.

Referring still to FIG. 3, in addition to the instance node 32, the instance node 36 for the object node represents the second chair object. The instance nodes 32 and 36 contain values for some of the assignable attributes for these two different chairs, while the basic information or definition about the chairs with fixed attributes is contained in the shared chair object node 34. More specifically, if the chair is going to be used with different seat colors in these two instances, the operator can easily control the process. First, the label of the seat color attribute within the chair object is located. The graphics editor is able to return the label of a single attribute of an object. The obtained seat color attribute label and the new value of that attribute, such as “white”, are saved in the instance node 32 or “Instance 1.” Similarly, when the chair occurs in the scene for the second time, the seat color attribute label and the new value of that attribute, such as “black”, are saved in the instance node 36 or “Instance 2” accordingly. Various attributes of Instance 1 and Instance 2 (two chairs) are resolved first through the default accumulation method from the attributes of the chair object, the attribute values in the Instance 1 and 2 nodes, and the scene node 30. For example, the seat color attribute of the chairs are found to be the deferred attribute in the Instance 1 and 2 nodes. In the case of Instance 1, the value for the deferred attribute changes the final attribute value to “white.” Similarly, the attributes for Instance 2 would set the chair seat attribute value to “black.” By doing so, an object can be reused with changes of some attributes as needed in a scene without creating or storing a new entity in the library.

When a change is made to some fixed attributes of the chair object in the library, for example, maple arms are added to the chair. Changes will be made universally wherever the chair node is used. No change is necessary to a particular scene.

The present invention thus allows a single predefined object to be used in several places of a computer graphic image with modifications. The object appears differently due to the differences between the previously determined values of some assignable attributes and the overriding values provided in an instance node of the object. By eliminating the need to save a copy of an object for each permutation of any attribute value, the number of saved objects in the library is significantly reduced.

Furthermore, by deferring the assignment of attribute values as described above, and sharing run-time instances of graphs representing certain objects in a scene, the size of the graph representing the scene is also reduced. In addition, certain changes made to objects stored in the library will be reflected in every scene using that object and no additional change is needed to a particular scene.

The present disclosure provides many different embodiments, or examples, for implementing different features of the invention. Specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A method for defining one or more reusable graphical objects with assignable attributes in a computer graphics scene, the method comprising:
defining at least one graphical object with at least one assignable attribute in its first instance added to the graphics scene; and
adding a second instance of the graphical object with the value for the at least one assignable attribute identified based on the need of the graphics scene,
wherein the first and second instances of the graphical object share a predetermined set of fixed attributes of the graphical object.

2. The method of claim 1 further comprising providing an initial value to each assignable attribute.

3. The method of claim 1 wherein the step of adding further comprises detecting the assignable attribute.

4. A method for reusing a graphical object in a computer graphics library with one or more assignable attributes, the method comprising:
providing initial values for the assignable attributes;
identifying at least one assignable attribute of the graphical object expected to be altered when an instance of the graphical object is used; and
altering the attribute value of the graphical object for the used instance,
wherein the used instance is stored in the library as an entity containing only the assignable attributes while sharing other attributes as defined by the object.

5. The method of claim 4 wherein the object is defined as a node in the library.

6. The method of claim 4 wherein the step of identifying further comprises including the assignable attribute and its initial value in a virtual instance node related to the object;
finding a predetermined attribute value for the identified assignable attribute from one or more nodes connected directly or indirectly with the node of the object; and
replacing the initial value of the assignable attribute with the found predetermined attribute value.

7. A system for reusing a graphical object in a computer graphics library with one or more assignable attributes, the system comprising:
means for providing initial values for the assignable attributes;
means for identifying at least one assignable attribute of the graphical object expected to be altered when an instance of the graphical object is used; and
means for altering the attribute value of the graphical object for the used instance,
wherein the used instance is stored in the library as an entity containing only the assignable attributes while sharing other attributes as defined by the object.

8. The system of claim 7 wherein the object is defined as a node in the library.

9. The system of claim 7 wherein the means for identifying further comprises means for:
including the assignable attribute and its initial value in a virtual instance node related to the object;
finding a predetermined attribute value for the identified assignable attribute from one or more nodes connected directly or indirectly with the node of the object; and
replacing the initial value of the assignable attribute with the found predetermined attribute value.
